(19) United States
(12) Patent Application Publication
(10) Pub. No.: US 2021/0012371 A1
(43) Pub. Date: Jan. 14, 2021

(54) DETERMINING MICRO-EXPRESSIONS OF A USER

(71) Applicant: Dell Products L. P., Round Rock, TX (US)

(72) Inventors: Sathish Kumar Bikumala, Round Rock, TX (US); James S. Watt, JR., Austin, TX (US); John Peter Raphael Hughan, Austin, TX (US)

(21) Appl. No.: 16/510,194

(22) Filed: Jul. 12, 2019

(51) Int. Cl. G06Q 30/02; G06F 16/958; G06F 16/9535; H04L 29/08; G06K 9/00

(52) U.S. Cl. CPC G06Q 30/0239; G06F 16/958; G06F 16/9535; G06K 9/00315; H04L 67/22; G06K 9/00248; H04L 67/2819

(57) ABSTRACT

In some examples, while a user is navigating a site using a browser, a computing device may receive one or more images from a camera and may monitor input data from input devices (e.g., mouse, keyboard). After a particular event occurs (e.g., a navigation event such as selecting a link, selecting a tab, scrolling up or down, or the like), the computing device may analyze the images captured after the event using a machine learning algorithm to determine a micro-expression of the user. The micro-expression may be classified as a particular sentiment of a plurality of sentiments, associated with the event, and sent to a server. The server or the computing device may instruct the browser to modify, based on the sentiment, a portion of the site. The modification may include displaying a user interface to enable the user to communicate with a representative associated with the site.

### BACKGROUND OF THE INVENTION

### Field of the Invention

This invention relates generally to determining a user's micro-expression when using a computing device and, more particularly to correlating micro-expressions of a user when using the computing device with the user's usage history to determine the user's sentiments at different points in time.

### Description of the Related Art

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently, user feedback associated with a site is determined by providing a user of a computing device with a survey or enabling the user to post a text-based review. However, such user feedback may not be entirely accurate as the user may rush through the survey. In addition, such user feedback may not provide detailed information about the user's interactions with the site. For example, the user feedback may not indicate which portions of a site the user enjoyed using, which portions the user did not enjoy using, and which portions the user had difficulty using.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, while a user is navigating a site using a browser, a computing device may receive one or more images from a camera and may monitor input data from input devices (e.g., mouse, keyboard). After a particular event occurs (e.g., a navigation event such as selecting a link, selecting a tab, scrolling up or down, or the like), the computing device may analyze the images captured after the event using a machine learning algorithm to determine a micro-expression of the user. The micro-expression may be classified as a particular sentiment of a plurality of sentiments, associated with the event, and sent to a server. The server or the computing device may instruct the browser to modify, based on the sentiment, a portion of the site. The modification may include displaying a user interface to enable the user to communicate with a representative associated with the site.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a computing device to determine a sentiment associated with an event, according to some embodiments.

FIG. 2 is a block diagram of a system that includes a computing device to send data to a server to enable the server to determine a sentiment associated with an event, according to some embodiments.

FIG. 3 is a block diagram illustrating determining sentiments in an event timeline, according to some embodiments.

FIG. 4 is a flowchart of a process that associates a sentiment with an event, according to some embodiments.

FIG. 5 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein may monitor, on a computing device, a user's facial expressions (e.g., micro-expressions) and use of input devices (e.g., mouse, keyboard, and the like) when navigating a site using a web browser. When a particular event occurs, such as the user navigating to a particular location on the site, the systems and techniques may capture the user's facial expressions in a set of images (e.g., video frames). A machine learning module may analyze the set of images to identify a micro-expression and a sentiment (e.g., happy, sad, puzzled, inquiring, or the like). The system and techniques may associate the sentiment with the event and send the data to a server. The server may receive such data from multiple (e.g., hundreds of thousands of) computing devices and analyze the data to identify feedback associated with the site, such as which portions of the site are frequently visited, which portions are liked by users, which portions are disliked by users, and the like.

In some cases, the computing device or the server may, substantially in real-time (e.g., less than one second after determining the user's micro-expression), modify the site based on the user's micro-expression. For example, if a user's micro-expression indicates that the user is squinting, the computing device (or the server) may automatically (e.g., without human interaction) modify at least a portion of the site by increasing a size of the content (e.g., by increasing a font size, magnifying an image, or the like) to enable the user to more easily view the content. As another example, if a user's micro-expression indicates that the user appears to be confused, the computing device (or the server) may automatically modify at least a portion of the site by substituting a simpler version of the content. To illustrate, if the user has a confused look when viewing the specifications of a computer on a site (e.g., www.Dell.com), then a simpler version of the specifications may be displayed. As yet another example, if a user's micro-expression indicates that the user appears to be confused or puzzled, the computing device (or the server) may ask the user if the user desires to chat with (e.g., instant messaging chat) or speak with a customer service representative (CSR). If the user indicates a desire to chat, then the system and techniques may open a chat window and connect the user with a CSR. If the user indicates a desire to speak with a CSR, then the system and techniques may display a phone number for the user to call or may ask the user to enter the user's contact number and then have a CSR initiate a call to the contact number. As a further example, a user viewing a technical support section of a site may request or be automatically connected, via a chat or a phone call, to a technical support specialist. Similarly, a user whose micro-expressions indicate the user desires to purchase an item may request or be automatically connected, via a chat or a phone call, to a sales specialist, and so on. Of course, these are merely example and other actions may be taken based on the user's micro-expression and the portion of the site that the user is viewing.

Thus, when a user is browsing a site, a camera may capture micro-expressions associated with the user. The micro-expressions may be associated with a particular event, such as the user viewing a particular portion of the site, selecting a link on the site, navigating to a particular portion of the site, navigating to a particular portion of a particular page of the site, or the like. The micro-expressions may, in some cases, be summarized in the form of a sentiment (e.g., happy, sad, confused, and the like) and sent to a server. For example, the sentiment may be summarized and sent to the server for privacy concerns, e.g., to protect an identity of the user. In other cases, the micro-expression and other information associated with the user may be sent to the server. In such cases, the site owner may provide an incentive to the user, such as a discount coupon or the like to the user, in exchange for the user sharing personal information. The server may collect sentiments associated with multiple users that are using multiple computing devices. In this way, the owner of the site can modify portions of the site that cause multiple users to have a non-happy (e.g., sad, unhappy, puzzled, or the like) micro-expression. The server may collect additional sentiments and determine that the modified portions of the site result in fewer non-happy micro-expressions and more happy micro-expressions. In this way, a site can be fine-tuned such that a majority (e.g., 60%, 70%, 80%, 90%, or the like, as defined by the site owner) of users have happy micro-expressions when viewing the various portions of the site.

In addition, the computing device (or the server) may modify portions of the site substantially in real-time based on the user's micro-expression (or sentiment). For example, if the micro-expression indicates that the user is squinting, the computing device (or server) may instruct the browser to increase a size of the portion of the site that the user is viewing, e.g., by increasing a font size, increasing an image size, or the like. If the micro-expression indicates that the user is unhappy, puzzled, or the like, the computing device (or server) may automatically (or in response to a user request) connect the user (via chat or phone call) to a representative (e.g., of the site owner) to obtain more information, report and resolve a technical issue, place an order, or the like.

By associating micro-expression information with customer browsing information and sending the data to a business for analysis, the business can identify which portions of a site users enjoy using and which portions users do not enjoy using. Such feedback is honest because it is based on each user's micro-expressions rather than a user's desire to rush through and answer survey questions. Micro-expressions may be determined at a predetermined interval (e.g., every P milliseconds, P>0), when specific browser events occur (e.g., page load, page exit, search initiated, link selection, or the like), or both. In some cases, the video images may be streamed to a server of a business for processing. In some cases, the customer user interface (UI) may be modified based on a user's micro-expression (e.g., an angry or a frustrated user may be prompted to chat or conduct a call with a customer service representative). Accurate insight into customer sentiment is a key differentiator for businesses, such as online retailers. Insight into sentiment can be analyzed using machine learning, enabling the customer experience to be improved based on the information.

As an example, a computing device may include one or more processors and one or more non-transitory computer-readable storage media to store instructions executable by the one or more processors to perform various operation. For example, the operations may include receiving input data from one or more input devices being used to navigate a site being displayed by a browser. The operations may include determining, based on the input data and the site, that an event occurred. For example, the event may be one of: (i) selecting a tab to navigate to a particular portion of the site, (ii) selecting a hyperlink to navigate to the particular portion of the site, (iii) selecting a menu item to navigate to the particular portion of the site, or (iv) scrolling up or down a page that is being displayed on the site to access the particular portion of the site. The operations may include determining that the user has not provided permission to access a camera that is connected to the computing device, displaying a message requesting the user's permission to receive one or more images from the camera, and displaying an incentive to the user to provide the permission. For example, the incentive may include a discount, a coupon, or the like for one or more products or services offered for acquisition (e.g., lease or purchase) on the site. The operations may include receiving one or more images from a camera that is connected to the computing device. The operations may include performing an analysis of at least one image of the one or more images. The operations may include determining, based on the analysis, that the at least one image includes a micro-expression of a user that is using the computing device. The operations may include determining a sentiment corresponding to the micro-expression, associating the sentiment with the event, and sending the sentiment and the event to a server. The sentiment may, for example, be one of a neutral sentiment, a surprise sentiment, a fear sentiment, a disgust sentiment, an angry sentiment, a happy sentiment, a sad sentiment, or a contempt sentiment. The operations may include determining that the sentiment is not the happy sentiment and sending one or more instructions to the browser. The one or more instructions may cause the browser to modify at least a portion of the site being displayed. For example, modifying at least the portion of the site being displayed may include (i) increasing a font size of at least the portion of the site, (ii) increasing an image size of an image included in the portion of the site, or both (i) and (ii). As another example, modifying at least the portion of the site being displayed may include displaying a contact user interface to enable the user to either contact a representative or be contacted by a representative. The contact may include one or more of a call, a chat, or an email between the user and the representative. The operations may include receiving one or more additional images from the camera, performing an additional analysis of the one or more additional images, determining based on the additional analysis, that the one or more additional images include a second micro-expression, determining a second sentiment corresponding to the second micro-expression, and determining that the second sentiment is the happy sentiment.

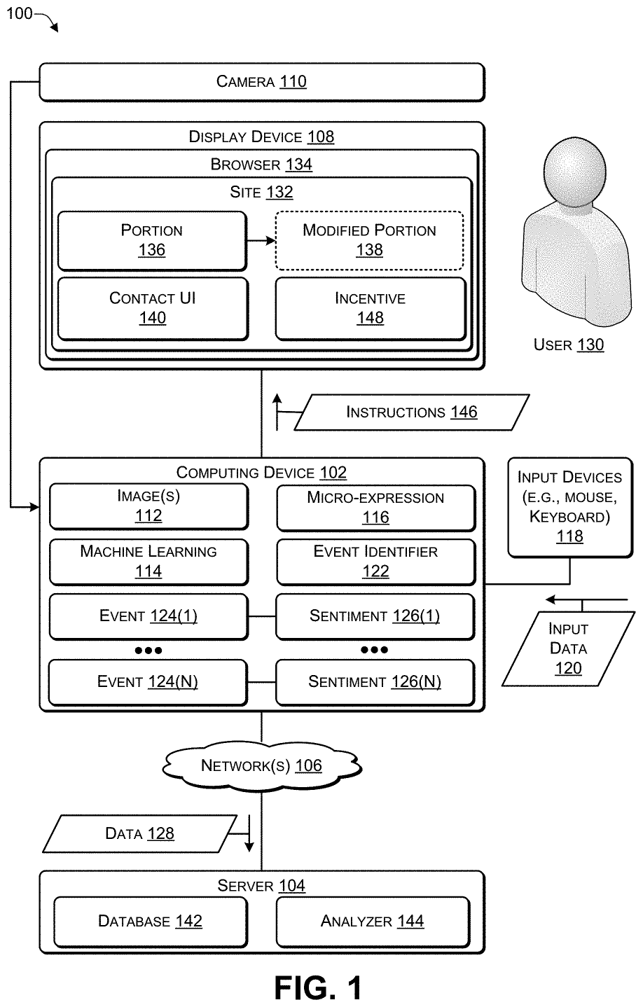

FIG. 1 is a block diagram of a system 100 that includes a computing device to determine a sentiment associated with an event, according to some embodiments. The system 100 includes a representative computing device 102 coupled to a server 104 via a network 106.

The computing device 102 may be connected to a display device 108 and a camera 110. The camera 110, the display device 108 or both may be separate from or integrated with the computing device 102. In some cases, the camera 110 may be integrated with the display device 108. For example, the computing device 102 may be a desktop computer, a laptop computer, a tablet, a smartphone, a smartwatch, another type of computing device, or any combination thereof.

The computing device 102 may receive one or more images 112 (e.g., a video stream) from the camera 110. The camera 110 may include a lens and a sensor. A machine learning module 114 may analyze a portion of the images 112 to determine a micro-expression 116 associated with the portion of the images 112. One or more input devices 118 (e.g., mouse, keyboard, and the like) may be connected to the computing device 102. An event identifier module 120 may analyze the input data 120 when a user 130 is navigating a site 132 using the browser 134 to identify an event 124(N) (where N>0). For example, the event identifier module 120 may determine, based on the browser 132, that the input data 120 indicates that the user has selected a tab, used a menu selection, selected a hyperlink or the like to navigate to a particular portion of the site 132. The machine learning module 114 may summarize the micro-expression 116 as a sentiment 126(N) and associate the sentiment 126(N) with the event 124(N). The sentiment 126(N) may be several words, and preferably a single word, that summarizes the micro-expression 116. Thus, as the user 130 navigates the site 132 using the browser 134 by providing input using one or more of the input devices 118, the computing device 102 may determine events 124(1) to 124(N) associated with the sentiments 126(1) to 126(N), respectively.

TABLE 1

| | | | User | | |
|---|---|---|---|---|---|
| Time | Event (e.g., URL) | Browser | Logged In? | Username | Sentiment |
| 12:34 CST | http://dell.com/search | Chrome | Yes | J_Smith | Neutral |
| 6-27-2019 | | | | | |
| 12:36 CST | http://dell.com/prod1 | Chrome | Yes | J_Smith | Surprised |
| 6-27-2019 | | | | | |
| 12:39 CST | http://dell.com/prod1/Spec | Chrome | Yes | J_Smith | Excited |
| 6-27-2019 | | | | | |
| 12:44 CST | http://dell.com/Cart | Chrome | Yes | J_Smith | Confused |
| 6-27-2019 | | | | | |
| 12:50 CST | http://dell.com/CheckOut | Chrome | Yes | J_Smith | Happy |
| 6-27-2019 | | | | | |

Table 1 illustrates an example of events 124 and corresponding sentiments 126. Each of the events 124 may include information, such as a universal resource locator (URL) identifying a location to which the user 120 navigated, portions of the URL that the user 130 was viewing (e.g., based on using eye tracking to track the eyes of the user 130 to identify which portions of a page the user 130 is viewing), a type of browser being used, a browser version, whether the user 130 is logged into the site 132, a username used to log into the site 132 (if the user 130 is logged in), and the like. In the events illustrated in Table 1, the user 130 may initially navigate to a site and perform a search for a particular type of product (event is http://dell.com/search) with a neutral sentiment (e.g., based on the user's micro-expression). When the user 130 reviews the search results, the user 130 may see a suitable product and select a link in the search results to view the product page (e.g., event is http://dell.com/prod1). When the user 130 views the product page, the user sentiment may be surprise because the user 130 is surprised to discover a suitable product. The user 130 may navigate to a portion of the site 132 that shows specifications of the product (e.g., event is http://dell.com/prod1/Spec) and have an excited sentiment because the product appears suitable. The user 130 may place the product in a cart (e.g., event is http://dell.com/Cart) and have a confused sentiment because the user is presented with multiple options (e.g., hardware upgrades, software upgrades, extended warranty, and the like). When the user 130 has checked out (e.g., event is http://dell.com/CheckOut), the user 130 may have a happy sentiment because the user has purchased the product.

The portion of the images 112 that the machine learning module 114 analyzes to determine the micro-expression 116 may be determined based on the events 124. For example, in the above example based on Table 1, a first portion of the images 112 may be analyzed from (i) a time associated with an event where the user navigates to the site 132 to (ii) the time of associated with an event where the user 130 enters search criteria to perform a search, to determine that the sentiment is neutral. A second portion of the images 112 may be analyzed from (i) a time associated with an event where the user selects a link in the search results to navigate to the product page to (ii) the time associated with an event where the user selects a link or a tab (or scrolls the page) to view the specification, to determine that the sentiment is surprised. A third portion of the images 112 may be analyzed from (i) a time associated with an event where the user selects a link or a tab (or scrolls the page) to view the specification to (ii) the time associated with an event where the user adds the product to a cart, to determine that the sentiment is excited. A fourth portion of the images 112 may be analyzed from (i) a time associated with an event where the user adds the product to a cart to (ii) the time associated with the event where the user completes the checkout process, to determine that the sentiment is confused. A fifth portion of the images 112 may be analyzed from (i) a time associated with the event where the user completes the checkout process to (ii) the time associated with the event where the user navigates to a different site, to determine that the sentiment is happy.

The images 112 may be captured at a predetermined frame rate, such as, for example, 30, 15, 10, 5, or 1 frame(s) per second (fps). In some cases, the images 112 may be captured for a predetermined amount of time (e.g., M seconds, M>0) after a particular type of event, such as navigation to a site, a search, selecting a link, or the like is performed. In the images 112, micro-expressions associated with the user 130 may be identified and linked to a site or a portion of a site. For example, the machine learning module 114 may use eye tracking to determine which portions of the site 132 that the user 130 is viewing. By determining which portions of the site 132 the user 130 is spending time viewing, the computing device 102 may determine a relative importance of each portion (relative to other portions) of the site 132 to the user 130. Thus, the images 112 may be captured at a predetermined time interval (e.g., every X millisecond, X>0), after the computing device 102 determines that a particular event (e.g., mouse click, scrolling using mouse or keyboard, page load, page refresh, change page, tab selection, or the like) has occurred, or any combination thereof.

In some cases, the sentiment 126 may be one of multiple micro-expressions, such as one of neutral, surprise, fear, disgust, anger, happiness, sadness, and contempt. The neutral micro-expression may include eyes and eyebrows neutral and the mouth opened or closed with few wrinkles. The surprise micro-expression may include raised eyebrows, stretched skin below the brow, horizontal wrinkles across the forehead, open eyelids, whites of the eye (both above and below the eye) showing, jaw open and teeth parted, or any combination thereof. The fear micro-expression may include one or more eyebrows that are raised and drawn together (often in a flat line), wrinkles in the forehead between (but not across) the eyebrows, raised upper eyelid, tense (e.g., drawn up) lower eyelid, upper (but not lower) whites of eyes showing, mouth open, lips slightly tensed or stretched and drawn back, or any combination thereof. The disgust micro-expression may include a raised upper eyelid, raised lower lip, wrinkled nose, raised cheeks, lines below the lower eyelid, or any combination thereof. The anger micro-expression may include eyebrows that are lowered and drawn together, vertical lines between the eyebrows, tense lower eyelid(s), eyes staring or bulging, lips pressed firmly together (with corners down or in a square shape), nostrils flared (e.g., dilated), lower jaw jutting out, or any combination thereof. The happiness micro-expression may include the corners of the lips drawn back and up, the mouth may be parted with teeth exposed, a wrinkle may run from the outer nose to the outer lip, cheeks may be raised, lower eyelid may show wrinkles, Crow's feet near the eyes, or any combination thereof. The sadness micro-expression may include the inner corners of the eyebrows drawn in and up, triangulated skin below the eyebrows, one or both corners of the lips drawn down, jaw up, lower lip pouts out, or any combination thereof. The contempt (e.g., hate) micro-expression may include one side of the mouth raised.

In some cases, the events 124 and associated sentiments 126 may be sent as data 128 to the server 104 via the network 106. For example, the privacy of the user 130 may be protected by sending the events 124 and the sentiments 126 to the server 104, but not sending the micro-expressions 116 or the images 112. In other cases, the images 112, the corresponding micro-expressions 116, the events 124, and the sentiments 126 may be sent to the server 104 for analysis. In such cases, the user 130 may be compensated for sharing personal data by being offered an incentive 148, such as a discount on products and/or services provided by the owner of the site 132 or the like. For example, if the computing device 102 determines that the user 130 has not provided permission to access the camera 110 to capture the images 112, then the computing device 102 may display the incentive 148 and request permission from the user 130 to capture the images 112 using the camera 110.

The data 128 may include the events 124, the sentiments 126 and, in some cases, the images 112 and/or the micro-expressions 116. The data 128 may be sent when one or more conditions are satisfied. For example, the data 128 may be sent from the computing device 102 to the server 104 when a number of events 124 satisfies a predetermined threshold (e.g., at least X events, X>0), when a size of the events 124 and the sentiments 126 satisfies a predetermined threshold (e.g., size>Y gigabytes (GB), Y>0), at a predetermined interval (e.g., every Z hours, Z>0), or any combination thereof.

The server 104 may store the data 128 in a database 142. For example, the database 142 may include data received from multiple computing devices (e.g., including the representative computing device 102) associated with multiple users (e.g., including the representative user 130). An analyzer module 144 may analyze the contents of the database 142 to identify which portions of the site 132 cause users to have a particular sentiment and address those portions of the site 132 that do not cause users to have a happy sentiment. In this way, the owner of the site 132 can improve the user experience for users that navigate the site 132.

In some cases, the computing device 102 (or the server 104) may send, substantially in real-time, instructions 146 to the site 132, based on the micro-expression 116. For example, if the micro-expression 116 indicates that the user 130 is squinting (e.g., narrowing of the eyes, eyebrows scrunched, corners of lips turn down, or any combination thereof), the computing device 102 (or the server 104) may send the instructions 146 to the browser 134 to increase a size of a portion 136 of the site 132 that the user 130 is viewing. The instructions 146 may cause the site 132 to modify the portion 136 to create a modified portion 138. The modifications may include increasing a font size, increasing an image size, increasing a graphic size, or the like. As another example, if the micro-expression 116 indicates the user 130 is not happy, the computing device 102 (or the server 104) may automatically connect the user 130 (via chat or phone call) to a representative (e.g., of the site owner) to obtain more information, report and resolve a technical issue, place an order, or the like. In some cases, the instructions 146 may cause the site 132 to display a contact user interface (UI) 140. The contact UI 140 may enable the user 130 to contact (e.g., chat or call) a representative, such as a customer service representative a sales representative, a technical support specialist, or the like. For example, the contact UI 140 may enable the user 130 to initiate a text chat, a video call, an audio call, or the like. The video call may use the camera 110. The audio call may use voice over internet protocol (VoIP) to initiate a call from the computing device 102 that uses a microphone and a speaker of the computing device 102. Alternately, the contact UI 140 may enable the user 130 to enter a phone number and have a representative of the site owner call the user 130 or the contact UI 140 may display a phone number that the user 130 can call. For example, if the computing device 102 (or the server 104) determines, based on the micro-expression 116 and the portion 136 of the site 132 that the user 130 is viewing (e.g., products on sale, special offers, or other purchase-related portions), that the user is interested in purchasing an item (e.g., a product or service), then the contact UI 140 may enable the user 130 to communicate with a sales representative. If the computing device 102 (or the server 104) determines, based on the micro-expression 116 and the portion 136 of the site 132 that the user 130 is viewing (e.g., technical support forum, technical support page, or the like), that the user is looking for technical support for a previously purchased product, then the contact UI 140 may enable the user 130 to communicate with a technical support specialist. If the computing device 102 (or the server 104) determines, based on the micro-expression 116 and the portion 136 of the site 132 that the user 130 is viewing, that the user is interested in purchasing an item (e.g., a product or service), then the contact UI 140 may enable the user 130 to communicate with a sales representative.

Thus, FIG. 1 illustrates how a computing device may receive images from a camera and analyze the images to identify micro-expressions associated with a user of the computing device. The computing device may capture the images at a particular rate. The computing device may monitor how the user navigates a site using a browser and may monitor the user's use of one or more input devices (e.g., mouse, keyboard, and the like) to determine when particular types of events occur. When an event occurs, the computing device may determine a time associated with the event, determine the user's micro-expression at about the same time (or within Y milliseconds after the event, 1<Y<0), determine a sentiment based on the micro-expression, and associate the sentiment with the event. The events and associated sentiments may be sent to a server to enable the owner of the site to modify the site to improve the user experience associated with the site by reducing the portions of the site that cause users to have a micro-expression that is not happy (or neutral) and to increase the portions of the site that cause users to have a micro-expression that is happy (or neutral).

In some cases, the computing device, the server, or both may send instructions to the site. For example, if the user appears in the images to be squinting, then the instructions may cause the site to increase a size of at least a portion of the site to enable the user to more easily view the portion of the site. For example, a font size of at least a portion of the site may be increased, a size of an image may be increased, or the like. If the user's micro-expression is not neutral or happy, the instructions may cause a contact UI to be displayed. The contact UI may enable the user to contact or be contacted by a representative or agent associated with the site owner. For example, the contact UI may enable the user to initiate a chat or call a representative (e.g., sales representative, technical support specialist, or the like) or have a representative contact (e.g., call, email, arrange for a demonstration over the internet or in a showroom, or the like) the user.

In the system 100, the computing device 102 has the capability (e.g., processing resources such as central processing unit (CPU), memory, and the like) to analyze the images 112 to identify the micro-expression 116 and determine the sentiments 126. However, not all computing devices may have such capabilities.

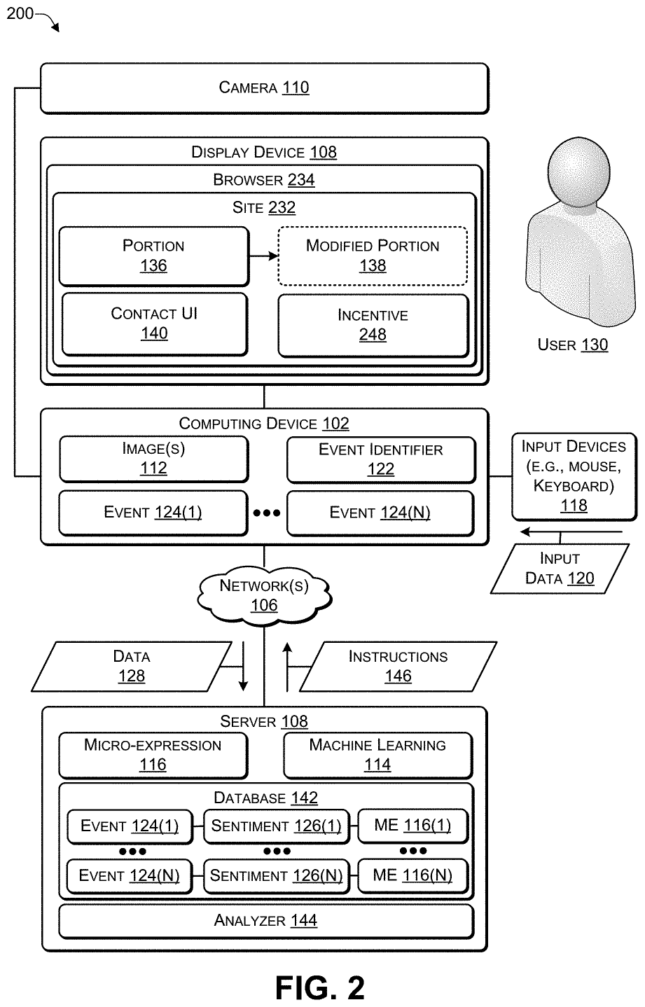

FIG. 2 is a block diagram of a system 200 that includes a computing device to send data to a server to enable the server to determine a sentiment associated with an event, according to some embodiments. The system 200 may be used when the computing device 102 lacks at least some of the capabilities (e.g., processing resources such as CPU, memory, and the like) to identify micro-expressions, sentiments, and the like. In the system 200, the computing device 102 may send data to the server 108 and the server 108 may analyze the data. Of course, in some cases, a combination of the systems 100 and 200 may be used in which some of the processing is performed by the computing device 102 and the remainder of the processing is performed by the server 108. It should be understood that the modules and other components displayed in FIG. 2 operate in a manner similar to that described in FIG. 1.

In FIG. 2, the computing device 102 may receive the images 112 from the camera 110. The computing device 102 may receive the input data 120 from the input devices 118 (e.g., mouse, keyboard, and the like) and the event identifier 122 may identify one of the events 124. The computing device 102 may send the data 128 to the server 108. In the example illustrated in FIG. 2, the data 128 may include the images 112 and at least one of the events 124. In some cases, the data 128 may include the input data 120 and the server 108 may host the event identifier 122 to identify the events 124.

The server 108 may use the machine learning module 114 to analyze the images 112 included in the data 128 to identify the corresponding one of the micro-expressions 116 based on the images 112. The server 108 may determine the corresponding sentiment 126 associated with each of the events 124 and store the event 124 and the corresponding sentiment 126 in the database 142. In some cases, the micro-expression 116 associated with each of the events 124 may be stored in the database 142 and used to further train the machine learning module 114.

Thus, FIG. 1 illustrates how a computing device may receive images from a camera and send the images to a server to analyze the images and identify micro-expressions associated with a user of the computing device. The computing device may monitor how the user navigates a site using a browser and may monitor the user's use of one or more input devices (e.g., mouse, keyboard, and the like) to determine when particular types of events occur. When an event occurs, the computing device may determine a time associated with the event, and send the event, along with images captured at about the same time (or within Y milliseconds after the event, 1<Y<0) to the server. The server may determine a sentiment based on the micro-expression, and associate the sentiment with the event. The server may store and analyze the events and associated sentiments to enable the owner of the site to modify the site to improve the user experience when navigating the site by reducing the portions of the site that cause users to have a micro-expression that is not happy (or neutral) and to increase the portions of the site that cause users to have a micro-expression that is happy (or neutral).

In some cases, the server may send instructions to the site. For example, if the user appears in the images to be squinting, then the instructions may cause the site to increase a size of at least a portion of the site to enable the user to more easily view the portion of the site. For example, a font size of at least a portion of the site may be increased, a size of an image may be increased, or the like. If the user's micro-expression is not neutral or happy, the instructions may cause a contact UI to be displayed. The contact UI may enable the user to contact or be contacted by a representative or agent associated with the site owner to resolve the user's issue(s) to make the user happy. For example, the contact UI may enable the user to initiate a chat or call a representative (e.g., sales representative, technical support specialist, or the like) or have a representative contact (e.g., call, email, arrange for a demonstration over the internet or in a showroom, or the like) the user.

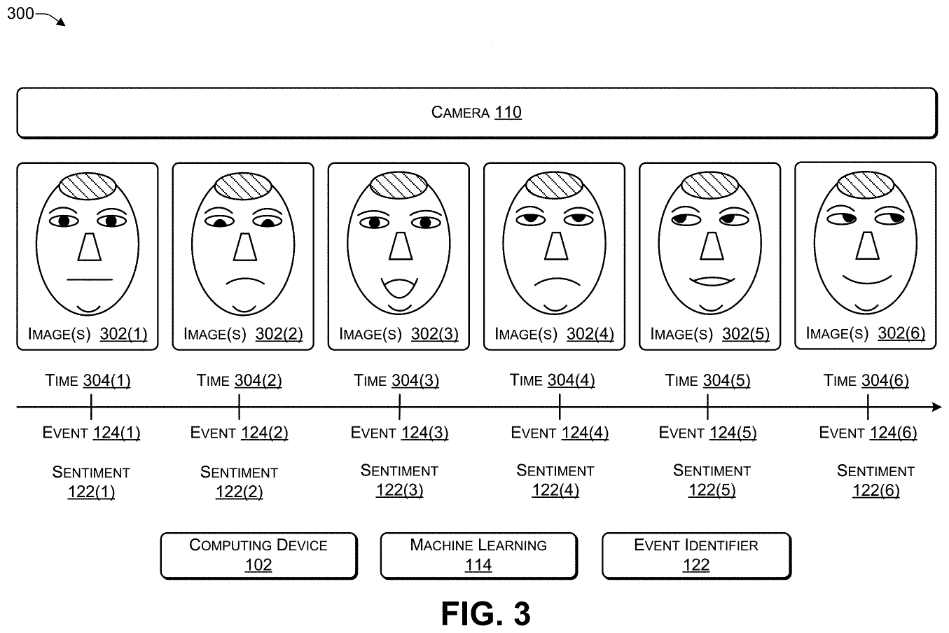

FIG. 3 is a block diagram 300 illustrating determining sentiments in an event timeline, according to some embodiments. FIG. 3 illustrates the type of information that may be determined based on the images 112 and the input data 120 of FIGS. 1 and 2.

The machine learning module 114 may analyze one or more images 302(1) (e.g., the images 112 of FIGS. 1 and 2) from the camera 110 and determine a sentiment 122(1) (e.g., neutral). Based on a timestamp associated with the images 302(1), the machine learning module 114 may determine a time 304(1) indicating when the user displayed the sentiment 122(1). The event identifier 122 may determine that the event 124(1) occurred at about the same time 304(1). In this way, the sentiment 122(1) is associated with the event 124(1) based on the time 304(1).

The machine learning module 114 may analyze one or more images 302(2) (e.g., the images 112 of FIGS. 1 and 2) from the camera 110 and determine a sentiment 122(2) (e.g., unhappy). In the images 302(2), the machine learning module 114 may use eye tracking to determine that the user is unhappy while viewing the bottom portion of a site. Based on a timestamp associated with the images 302(2), the machine learning module 114 may determine a time 304(2) indicating when the user displayed the sentiment 122(2). The event identifier 122 may determine that the event 124(3) (e.g., viewing the bottom portion of the site) occurred at about the same time 304(2). In this way, the sentiment 122(2) is associated with the event 124(2) based on the time 304(2).

The machine learning module 114 may analyze one or more images 302(3) (e.g., the images 112 of FIGS. 1 and 2) from the camera 110 and determine a sentiment 122(3) (e.g., happy). In the images 302(3), the machine learning module 114 may use eye tracking to determine that the user is happy while looking at the middle portion of a site. Based on a timestamp associated with the images 302(3), the machine learning module 114 may determine a time 304(3) indicating when the user displayed the sentiment 122(3). The event identifier 122 may determine that the event 124(3) (e.g., viewing the middle portion of the site) occurred at about the same time 304(3). In this way, the sentiment 122(3) is associated with the event 124(3) based on the time 304(3).

The machine learning module 114 may analyze one or more images 302(4) (e.g., the images 112 of FIGS. 1 and 2) from the camera 110 and determine a sentiment 122(4) (e.g., unhappy). In the images 302(4), the machine learning module 114 may use eye tracking to determine that the user is unhappy while looking at the top portion of a site. Based on a timestamp associated with the images 302(4), the machine learning module 114 may determine a time 304(4) indicating when the user displayed the sentiment 122(4). The event identifier 122 may determine that the event 124(4) (e.g., viewing the top portion of the site) occurred at about the same time 304(4). In this way, the sentiment 122(4) is associated with the event 124(4) based on the time 304(4).

The machine learning module 114 may analyze one or more images 302(5) (e.g., the images 112 of FIGS. 1 and 2) from the camera 110 and determine a sentiment 122(5) (e.g., neutral). In the images 302(5), the machine learning module 114 may use eye tracking to determine that the user is neutral while looking at the top right portion of a site. Based on a timestamp associated with the images 302(5), the machine learning module 114 may determine a time 304(5) indicating when the user displayed the sentiment 122(5). The event identifier 122 may determine that the event 124(5) (e.g., viewing the top tight portion of the site) occurred at about the same time 304(5). In this way, the sentiment 122(5) is associated with the event 124(5) based on the time 304(5).

The machine learning module 114 may analyze one or more images 302(6) (e.g., the images 112 of FIGS. 1 and 2) from the camera 110 and determine a sentiment 122(6) (e.g., happy). In the images 302(6), the machine learning module 114 may use eye tracking to determine that the user is happy while viewing the top left portion of a site. Based on a timestamp associated with the images 302(6), the machine learning module 114 may determine a time 304(6) indicating when the user displayed the sentiment 122(6). The event identifier 122 may determine that the event 124(6) (e.g., viewing the top left portion of the site) occurred at about the same time 304(6). In this way, the sentiment 122(6) is associated with the event 124(6) based on the time 304(6). Each of the sentiments 122 may include several words, and preferably a single word, that summarizes the corresponding micro-expression in the corresponding one of the images 302.

Thus, images may be analyzed to identify a micro-expression of a user, at what time the user displayed the micro-expression, what event occurred at about the same time (e.g., within X milliseconds, X>0), what sentiment is associated with the micro-expression, which portion of the site the user was viewing, and the like. By analyzing data from multiple computing devices, a site owner can determine which portions of a site cause a majority (e.g., 50%, 60%, 70%, 80% or the like) of users to have a non-happy (e.g., neutral, unhappy, or the like) micro-expression and modify the portions to reduce the percentage of users that have a non-happy micro-expression and increase the percentage of users that have a happy micro-expression. In some cases, portions of the site may be modified substantially in real-time to determine whether the modified portion causes the user's micro-expression to change from non-happy to happy (or at least neutral). In this way, site owner can continually refine a site to improve each user's experience and, in some cases, provide each user with a customized experience by modifying portions of the site based on the user's micro-expressions.

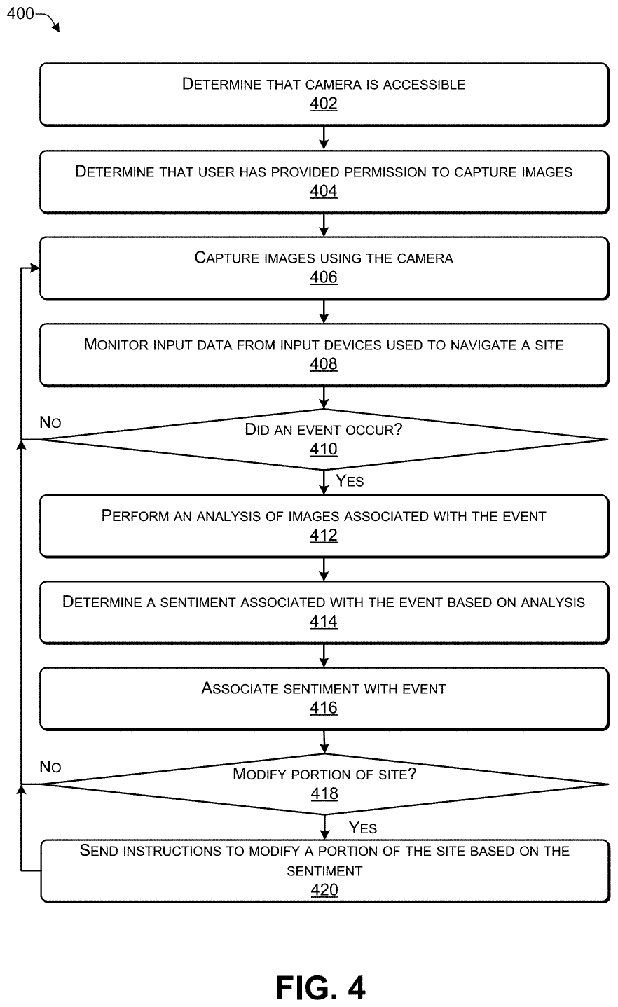

In the flow diagram of FIG. 4, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 400 is described with reference to FIGS. 1, 2, and 3 as described above, although other models, frameworks, systems and environments may be used to implement this process.

FIG. 4 is a flowchart of a process 400 that associates a sentiment with an event, according to some embodiments. The process 400 may be performed by the computing device 102 of FIGS. 1 and 2, the server 104, or a combination of both.

At 402, the process may determine that a camera is accessible. At 404, the process may determine that a user has provided permission to capture images (of the user). For example, in FIG. 1, the computing device 102 may determine whether the camera 110 is accessible. If the computing device 102 determines that the camera 110 is accessible, the computing device 102 may determine (e.g., based on a user profile or a user preferences file) whether the user 130 has provided permission to capture images of the user 130. If the computing device 102 determines that the camera 110 is not accessible or that the user 130 has not provided permission to capture images of the user 130, the computing device 102 may display a window on the display device 108 requesting the user's permission to access the camera 110 to capture images. In some cases, the user may be offered an incentive (e.g., discount, coupon, or other incentive) to provide permission to capture images of the user 130.

At 406, the process may capture one or more images using the camera. At 408, the process may monitor input data, from one or more input devices, that is being used to navigate a site (e.g., via a browser). For example, in FIG. 1, the computing device 102 may receive the images 112 from the camera 110. The computing device 102 may monitor (e.g., using the event identifier 122) the input data 120 during the time that the user 130 is navigating the site 132 using the input devices 118.

At 410, the process may determine whether an event occurred. If the process determines, at 410, that an event did not occur, then the process may proceed to 406 to capture additional images using the camera. If the process determines, at 410, that an event occurred, then the process may proceed to 412. At 412, the process may perform an analysis of images associated with the event. At 414, the process may determine a sentiment associated with the event based on the analysis. At 416, the process may associate the sentiment with the event. For example, in FIG. 1, the event identifier 122 may determine whether a particular event (e.g., from a set of predefined events) has occurred based on the input data 120 used to navigate the site 132. If the event identifier 122 determines that a particular event has not occurred, the computing device 102 may continue to receive the images 112 from the camera 110. If the event identifier 122 determines that a particular event (e.g., tab selection, page scroll, hyperlink selection, menu selection, or the like) has occurred, the computing device 102 (or the server 104) may analyze the images 112 that occurred just after the time that the event occurred. For example, at a particular point in time, the user may make a selection (e.g., by selecting a tab, a menu item, a hyperlink or the like) to navigate to a particular portion of the site 132. The event identifier 122 may identify the selection as an event (e.g., the event 124(N)). As the user is viewing the particular portion of the site 132, the user's face may be captured in the images 112 by the camera 110. The computing device 102 (or the server 104) may analyze the images 112 to determine that the images 112 include the micro-expression 116. The computing device 102 (or the server 104) may determine a sentiment (e.g., the sentiment 126(N)) and associate the sentiment with the corresponding event (e.g., the event 124(N)). In this example, the micro-expression 116 occurs in the images 112 captured after the event (e.g., navigation selection) occurs. In some cases, the images 112 may be captured at predetermined time intervals while in other cases, the images 112 may be captured after the event (e.g., navigation selection) occurs and until a second event (e.g., a second navigation selection) occurs.

At 418, the process may determine whether to modify at least a portion of the site. If the process determines, at 418, not to modify at least a portion of the site, then the process may proceed to 406 to capture additional images using the camera. If the process determines, at 418, to modify at least a portion of the site, then the process may proceed to 420 and send instructions to modify at least a portion of the site based on the sentiment. For example, in FIG. 1, the computing device 102 (or the server 104) may send, substantially in real-time, instructions 146 to the site 132, based on the micro-expression 116. For example, if the micro-expression 116 indicates that the user 130 is squinting (e.g., narrowing of the eyes, eyebrows scrunched, corners of lips turn down, or any combination thereof), the computing device 102 (or the server 104) may send the instructions 146 to the browser 134 to increase a size of a portion 136 of the site 132 that the user 130 is viewing. The instructions 146 may cause the site 132 to modify the portion 136 to create a modified portion 138. The modifications may include increasing a font size, increasing an image size, increasing a graphic size, or the like. As another example, if the micro-expression 116 indicates the user 130 is not happy, the computing device 102 (or the server 104) may automatically connect the user 130 (via chat or phone call) to a representative (e.g., of the site owner) to obtain more information, report and resolve a technical issue, place an order, or the like. In some cases, the instructions 146 may cause the site 132 to display a contact user interface (UI) 140. The contact UI 140 may enable the user 130 to contact (e.g., chat or call) a representative, such as a customer service representative a sales representative, a technical support specialist, or the like. For example, the contact UI 140 may enable the user 130 to initiate a text chat, a video call, an audio call, or the like. The contact UI 140 may enable the user 130 to enter a phone number and have a representative of the site owner call the user 130 or the contact UI 140 may display a phone number that the user 130 can call. For example, the contact UI 140 may enable the user 130 to communicate with a sales representative, a technical support specialist, with a product specialist (e.g., to schedule a demonstration), or the like.

Thus, a computing device may receive images from a camera. The computing device (or a server) may analyze the images to identify micro-expressions associated with a user of the computing device when the user is navigating a site using a browser. The computing device may monitor how the user navigates a site using a browser and may monitor the user's use of one or more input devices (e.g., mouse, keyboard, and the like) to determine when particular types of events occur. When an event occurs, the computing device may determine a time associated with the event, determine the user's micro-expression at about the same time, determine a sentiment based on the micro-expression, and associate the sentiment with the event. The events and associated sentiments may be stored at a server to enable the owner of the site to modify the site to improve the user experience associated with the site by reducing the portions of the site that cause users to have a micro-expression that is not happy (or neutral) and to increase the portions of the site that cause users to have a micro-expression that is happy (or neutral). Based on the sentiment and/or micro-expression, the computing device, the server, or a combination thereof may send instructions to the site. For example, if the user appears in the images to be squinting, then the instructions may cause the site to increase a size of at least a portion of the site to enable the user to more easily view the portion of the site. For example, a font size of at least a portion of the site may be increased, a size of an image may be increased, or the like. If the user's micro-expression is not neutral or happy, the instructions may cause a contact UI to be displayed. The contact UI may enable the user to contact or be contacted by a representative or agent associated with the site owner. For example, the contact UI may enable the user to initiate a chat or call a representative (e.g., sales representative, technical support specialist, or the like) or have a representative contact (e.g., call, email, arrange for a demonstration over the internet or in a showroom, or the like) the user.

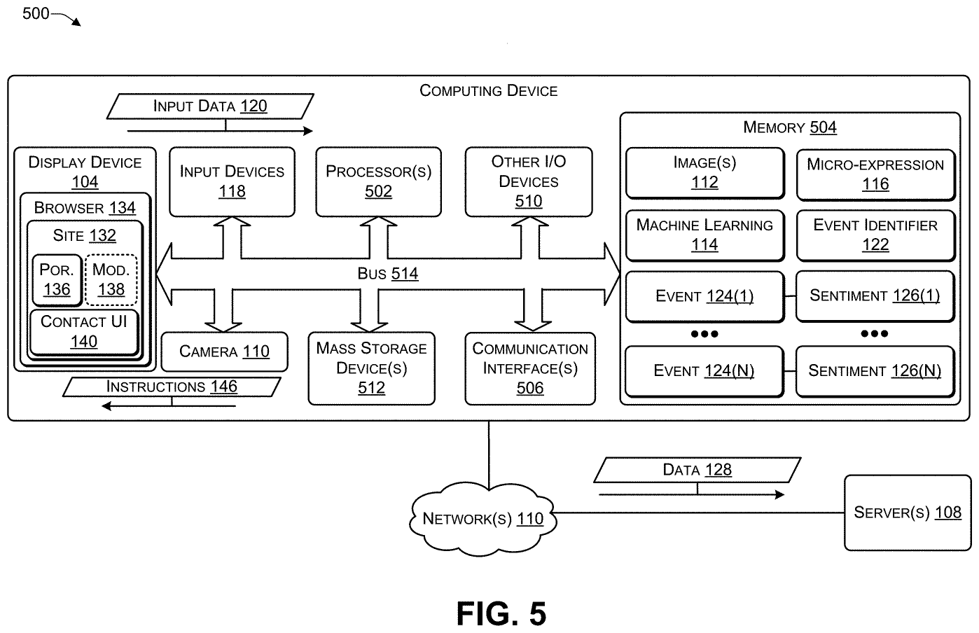

FIG. 5 illustrates an example configuration of a computing device 500 that can be used to implement the computing device 102 or the server 104 of FIGS. 1 and 2. As illustrated in FIG. 5, the computing device 500 may be used to implement the computing device 102 of FIGS. 1 and 2.

The computing device 102 may include one or more processors 502 (e.g., CPU, GPU, or the like), a memory 504, communication interfaces 506, a display device 508, the input devices 118, other input/output (I/O) devices 510 (e.g., trackball and the like), and one or more mass storage devices 512 (e.g., disk drive, solid state disk drive, or the like), configured to communicate with each other, such as via one or more system buses 514 or other suitable connections. While a single system bus 514 is illustrated for ease of understanding, it should be understood that the system buses 514 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 502 are one or more hardware devices that may include a single processing unit or a number of processing units, all of which may include single or multiple computing units or multiple cores. The processors 502 may include a graphics processing unit (GPU) that is integrated into the CPU or the GPU may be a separate processor device from the CPU. The processors 502 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 502 may be configured to fetch and execute computer-readable instructions stored in the memory 504, mass storage devices 512, or other computer-readable media.

Memory 504 and mass storage devices 512 are examples of computer storage media (e.g., memory storage devices) for storing instructions that can be executed by the processors 502 to perform the various functions described herein. For example, memory 504 may include both volatile memory and non-volatile memory (e.g., RAM, ROM, or the like) devices. Further, mass storage devices 512 may include hard disk drives, solid-state drives, removable media, including external and removable drives, memory cards, flash memory, floppy disks, optical disks (e.g., CD, DVD), a storage array, a network attached storage, a storage area network, or the like. Both memory 504 and mass storage devices 512 may be collectively referred to as memory or computer storage media herein and may be any type of non-transitory media capable of storing computer-readable, processor-executable program instructions as computer program code that can be executed by the processors 502 as a particular machine configured for carrying out the operations and functions described in the implementations herein.

The computing device 500 may include one or more communication interfaces 506 for exchanging data via the network 106 (e.g., when the computing device 500 is connected to the dock 104). The communication interfaces 506 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 506 can also provide communication with external storage, such as a storage array, network attached storage, storage area network, cloud storage, or the like.

The display device 508 may be used for displaying content (e.g., information and images) to users. Other I/O devices 510 may be devices that receive various inputs from a user and provide various outputs to the user, and may include a keyboard, a touchpad, a mouse, a printer, audio input/output devices, and so forth. The computer storage media, such as memory 116 and mass storage devices 512, may be used to store software and data, such as, for example, the images 112, the micro-expression(s) 116, the machine learning module 114, the event identifier module 122, the events 124, and the sentiments 126.

The computing device 500 may receive the images 112 from the camera 110 and analyze the images 112 to identify a micro-expression 116 associated with a user of the computing device 500. The computing device 500 may monitor how the user navigates the site 132 using the browser 134 by monitoring the user's use of the input devices 118 (e.g., mouse, keyboard, and the like) to determine when particular types of events occur. When an event occurs (e.g., one of the events 124), the computing device 500 may determine a time associated with the event, determine the user's micro-expression 116 at about the same time (or within Y milliseconds after the event, 1<Y<0), determine a sentiment (e.g., one of the sentiments 126) based on the micro-expression 116, and associate the sentiment 126 with the event 124. The events 124 and associated sentiments 126 may be sent to the server 108 to enable the owner of the site to modify the site 132 to improve the user experience associated with the site 132 by reducing the portions of the site 132 that cause users to have a micro-expression that is not happy (or neutral) and to increase the portions of the site 132 that cause users to have a micro-expression that is happy (or neutral).

In some cases, the computing device 500, the server 104, or a combination thereof may send the instructions 146 to modify the site 132. For example, if the user appears in the images to be squinting, then the instructions 146 may cause the site 132 to increase a size of at least the portion 136 of the site 132 to create the modified portion 138. For example, a font size of the portion 136 of the site 132 may be increased, a size of an image may be increased, or the like. If the user's micro-expression is not neutral or happy, the instructions 146 may cause the contact UI 140 to be displayed. The contact UI 140 may enable the user to contact or be contacted by a representative or agent associated with the site owner. For example, the contact UI 140 may enable the user to initiate a chat or call a representative (e.g., sales representative, technical support specialist, or the like) or have a representative contact (e.g., call, email, arrange for a demonstration over the internet or in a showroom, or the like) the user.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving, by one or more processors of a computing device, input data from one or more input devices being used to navigate a site displayed by a browser;
determining, by the one or more processors and based on the input data and the site, that an event occurred;
receiving, by the one or more processors, one or more images from a camera that is connected to the computing device;
performing an analysis, by the one or more processors, of at least one image of the one or more images;
determining, by the one or more processors and based on the analysis, that the at least one image includes a micro-expression of a user that is using the computing device;
determining, by the one or more processors, a sentiment corresponding to the micro-expression;
associating, by the one or more processors, the sentiment with the event; and
sending, by the one or more processors, the sentiment and the event to a server.

2. The method of claim 1, further comprising:
determining that the sentiment is not a happy sentiment; and
sending one or more instructions to the browser, wherein the one or more instructions cause the browser to modify at least a portion of the site being displayed.

3. The method of claim 2, wherein modifying at least the portion of the site being displayed comprises at least one of:
increasing a font size of at least the portion of the site; or
increasing an image size of an image included in the portion of the site.

4. The method of claim 2, wherein modifying at least the portion of the site being displayed comprises:
displaying a contact user interface to enable the user to either contact a representative or be contacted by a representative, wherein the contact comprises one or more of a call, a chat, or an email.

5. The method of claim 2, further comprising:
receiving one or more additional images from the camera;
performing an additional analysis of the one or more additional images;
determining based on the additional analysis, that the one or more additional images include a second micro-expression;
determining a second sentiment corresponding to the second micro-expression; and
determining that the second sentiment is the happy sentiment.

6. The method of claim 1, wherein the event comprises one of:
selecting a tab to navigate to a particular portion of the site;
selecting a hyperlink to navigate to the particular portion of the site;
selecting a menu item to navigate to the particular portion of the site; or
scrolling up or down a page that is being displayed on the site to access the particular portion of the site.

7. The method of claim 1, wherein the sentiment comprises one of:
a neutral sentiment, a surprise sentiment, a fear sentiment, a disgust sentiment, an angry sentiment, a happy sentiment, a sad sentiment, or a contempt sentiment.

8. A computing device comprising:
one or more processors; and
one or more non-transitory computer-readable storage media to store instructions executable by the one or more processors to perform operations comprising:
receiving input data from one or more input devices being used to navigate a site displayed by a browser;
determining, based on the input data and the site, that an event occurred;
receiving one or more images from a camera that is connected to the computing device;
performing an analysis of at least one image of the one or more images;
determining, based on the analysis, that the at least one image includes a micro-expression of a user that is using the computing device;
determining a sentiment corresponding to the micro-expression;
associating the sentiment with the event; and
sending the sentiment and the event to a server.

9. The computing device of claim 8, wherein the operations further comprise:
determining that the sentiment is not a happy sentiment; and
sending one or more instructions to the browser, wherein the one or more instructions cause the browser to modify at least a portion of the site being displayed.

10. The computing device of claim 9, wherein modifying at least the portion of the site being displayed comprises at least one of:
increasing a font size of at least the portion of the site; or
increasing an image size of an image included in the portion of the site.

11. The computing device of claim 9, wherein modifying at least the portion of the site being displayed comprises:
displaying a contact user interface to enable the user to either contact a representative or be contacted by a representative, wherein the contact comprises one or more of a call, a chat, or an email.

12. The computing device of claim 9, further comprising:
receiving one or more additional images from the camera;
performing an additional analysis of the one or more additional images;
determining based on the additional analysis, that the one or more additional images include a second micro-expression;
determining a second sentiment corresponding to the second micro-expression; and
determining that the second sentiment is the happy sentiment.

13. The computing device of claim 8, wherein the event comprises one of:
selecting a tab to navigate to a particular portion of the site;
selecting a hyperlink to navigate to the particular portion of the site;
selecting a menu item to navigate to the particular portion of the site; or
scrolling up or down a page that is being displayed on the site to access the particular portion of the site.

14. The computing device of claim 8, wherein, before receiving the one or more images from the camera, the operations further comprise:
determining that the user has not provided permission to receive the one or more images from the camera;
displaying a message requesting the permission to receive the one or more images from the camera; and
displaying an incentive to provide the permission.

15. One or more non-transitory computer readable media storing instructions executable by an embedded controller to perform operations comprising:
receiving input data from one or more input devices being used to navigate a site displayed by a browser;
determining, based on the input data and the site, that an event occurred;
receiving one or more images from a camera that is connected to the computing device;
performing an analysis of at least one image of the one or more images;
determining, based on the analysis, that the at least one image includes a micro-expression of a user that is using the computing device;
determining a sentiment corresponding to the micro-expression;
associating the sentiment with the event; and
sending the sentiment and the event to a server.

16. The one or more non-transitory computer readable media of claim 15, wherein the operations further comprise:
determining that the sentiment is not a happy sentiment; and
sending one or more instructions to the browser, wherein the one or more instructions cause the browser to modify at least a portion of the site being displayed.

17. The one or more non-transitory computer readable media of claim 16, wherein modifying at least the portion of the site being displayed comprises at least one of:
increasing a font size of at least the portion of the site; or
increasing an image size of an image included in the portion of the site.

18. The one or more non-transitory computer readable media of claim 16, wherein modifying at least the portion of the site being displayed comprises:
displaying a contact user interface to enable the user to either contact a representative or be contacted by a representative, wherein the contact comprises one or more of a call, a chat, or an email.

19. The one or more non-transitory computer readable media of claim 16, receiving one or more additional images from the camera;
performing an additional analysis of the one or more additional images;
determining based on the additional analysis, that the one or more additional images include a second micro-expression;
determining a second sentiment corresponding to the second micro-expression; and
determining that the second sentiment is the happy sentiment.

20. The one or more non-transitory computer readable media of claim 15, wherein, before receiving the one or more images from the camera, the operations further comprise:
determining that the user has not provided permission to receive the one or more images from the camera;
displaying a message requesting the permission to receive the one or more images from the camera; and
displaying an incentive to provide the permission.
